(19) United States
(12) Patent Application Publication
(10) Pub. No.: US 2017/0045967 A1
(43) Pub. Date: Feb. 16, 2017

(54) METHOD AND DEVICE FOR DETECTING TOUCH PRESSURE IN MOBILE TERMINAL

(71) Applicant: Xiaomi Inc., Beijing (CN)

(72) Inventors: Guosheng Li, Beijing (CN); Anyu Liu, Beijing (CN); Shuangquan Pan, Beijing (CN)

(73) Assignee: Xiaomi Inc., Beijing (CN)

(21) Appl. No.: 15/160,348

(22) Filed: May 20, 2016

(30) Foreign Application Priority Data
Aug. 12, 2015 (CN) 201510494192.0

(51) Int. Cl. G06F 3/044; G06F 3/041

(52) U.S. Cl. CPC G06F 3/044; G06F 3/0414

(57) ABSTRACT

Methods and devices are disclosed for detecting touch pressure on a display panel including one or more transparent electrodes. In one implementation, a method includes detecting one or more capacitance values corresponding to each of one or more capacitors formed between the one or more transparent electrodes and a support array in the display panel, determining a representative capacitance value from the detected one or more capacitance values, and determining a pressure value exerted on the display panel according to at least the representative capacitance value.

This application is based on and claims priority to Chinese Patent Application Serial No. 201510494192.0, filed with the State Intellectual Property Office of P. R. China on Aug. 12, 2015, the entire content of which is incorporated herein by reference.

### FIELD

The present disclosure relates to the field of display technology, and more particularly to a method and a device for detecting touch pressure in a mobile terminal.

### BACKGROUND

A touch panel may be integrated with a liquid crystal display panel. Two-dimensional coordinate positions of user touches on the touch panel may be sensed based on position-dependent capacity change induced by the touches on the touch panel. The traditional detection technology does not provide determination of touch pressure.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, a method for detecting touch pressure on a display panel comprising one or more transparent electrodes is disclosed. The method comprises: detecting one or more capacitance values corresponding to each of one or more capacitors formed between the one or more transparent electrodes and a support array in the display panel; determining a representative capacitance value from the detected one or more capacitance values; and determining a pressure value exerted on the display panel according to at least the representative capacitance value.

In another embodiment, a device is disclosed, comprising a display panel; one or more transparent electrodes in the display panel; a support array in the display panel; and a processor is configured to: detect one or more capacitance values corresponding to each of one or more capacitors formed between the one or more transparent electrodes and the support array in the display panel; determine a representative capacitance value from the detected one or more capacitance values; and determine a pressure value exerted on the display panel according to at least the representative capacitance value.

In yet another embodiment, a non-transitory computer readable storage medium having stored therein instructions is disclosed. The instructions, when executed by a processor of an electronic device having one or more transparent electrodes in a display panel, cause the electronic device to detect one or more capacitance values corresponding to each of one or more capacitors formed between the one or more transparent electrodes and a support array in the display panel; determine a representative capacitance value from the detected one or more capacitance values; and determine a pressure value exerted on the display panel according to at least the representative capacitance value.

### BRIEF DESCRIPTION OF THE DRAWINGS

The accompanying drawings, which are incorporated into and form a part of the specification, illustrate embodiments consistent with the present invention and, together with the disclosure, serve to explain the principles of the invention. These and other aspects and advantages of embodiments of the present disclosure will become apparent and more readily appreciated from the following descriptions made with reference to the drawings.

FIG. 1 is a flow chart of a method for detecting touch pressure according to an example embodiment of the present disclosure.

FIG. 2 is a schematic diagram of a liquid crystal display for detecting touch pressure and/or coordinate positon of a touch according to an example embodiment of the present disclosure.

FIG. 3 is a schematic diagram of a liquid crystal layer for detecting touch pressure and/or coordinate positon of a touch according to an example embodiment of the present disclosure.

FIG. 4 is a schematic diagram of another liquid crystal layer for detecting touch pressure and/or coordinate positon of a touch according to an example embodiment of the present disclosure.

FIG. 5 is a schematic diagram of a plurality of transparent electrodes in a transverse and parallel arrangement.

FIG. 6 is a schematic diagram of a plurality of transparent electrodes in a longitudinal and parallel arrangement.

FIG. 7 is a schematic diagram of a plurality of transparent electrodes in a transverse and parallel arrangement and a plurality of transparent electrodes in a longitudinal and parallel arrangement.

FIG. 8 is a flow chart of a method for detecting pressure and/or coordinate position of a touch according to an example embodiment of the present disclosure.

FIG. 9 is a block diagram of a device for detecting touch pressure and/or coordinate positon of a touch according to an example embodiment of the present disclosure.

FIG. 10 is a block diagram of the detecting module of the device in FIG. 9 according to an example embodiment of the present disclosure.

FIG. 11 is a block diagram of the detecting unit in the detecting module of FIG. 10 according to an example embodiment of the present disclosure.

FIG. 12 is a block diagram of the calculating unit in the detecting module of FIG. 10 according to an example embodiment of the present disclosure.

FIG. 13 is a block diagram of a device for detecting touch pressure and/or coordinate positon of the touch according to an example embodiment of the present disclosure.

### DETAILED DESCRIPTION

Reference will now be made in detail to exemplary embodiments, examples of which are illustrated in the accompanying drawings. The following description refers to the accompanying drawings in which same numbers in different drawings represent same or similar elements unless otherwise described. The implementations set forth in the following description of exemplary embodiments do not represent all implementations consistent with the invention. Instead, they are merely examples of devices and methods consistent with aspects related to the invention as recited in the appended claims.

Terms used in the disclosure are only for purpose of describing particular embodiments, and are not intended to be limiting. The terms “a”, “said” and “the” used in singular form in the disclosure and appended claims are intended to include a plural form, unless the context explicitly indicates otherwise. It should be understood that the term “and/or” used in the description means and includes any or all combinations of one or more associated and listed terms.

It should be understood that, although the disclosure may use terms such as “first”, “second” and “third” to describe various information, the information should not be limited herein. These terms are only used to distinguish information of the same type from each other. For example, first information may also be referred to as second information, and the second information may also be referred to as the first information, without departing from the scope of the disclosure. Based on context, the word “if” used herein may be interpreted as “when”, or “while”, or “in response to a determination”.

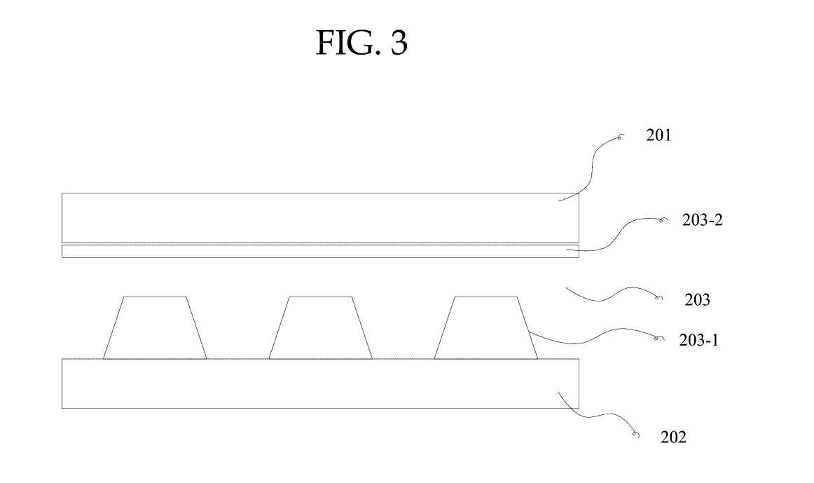

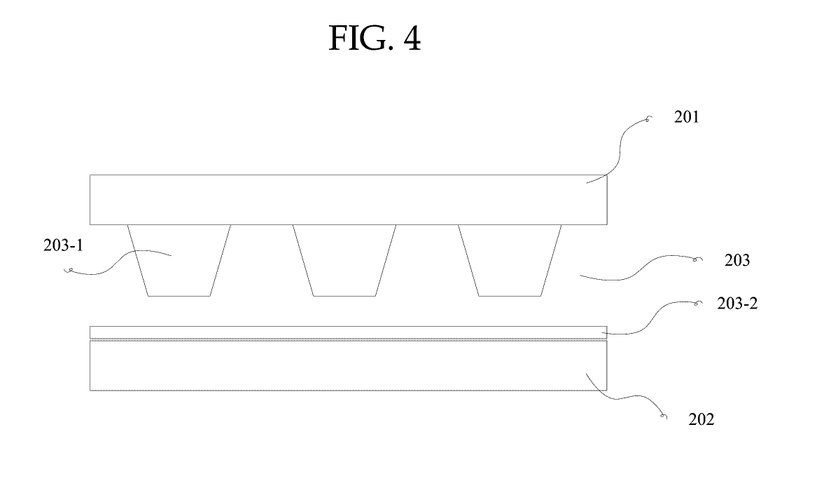

By way of introduction, the embodiments of the present disclosure provide methods and apparatus for detecting touch pressure on a display panel of an electronic device such as a mobile terminal. The electronic device may comprise a liquid crystal display (LCD) panel. The LCD panel may comprise a liquid crystal layer having therein a transparent electrode and a support array (see FIG. 3 and FIG. 4 and description therein). A user may use the LCD panel as an input device to sense pressure of touches/presses on the LCD panel. Specifically, presses on LCD panel may result in a pressure-dependent deformation of the transparent electrode at the point of press, leading to a pressure-dependent change of capacitance between the transparent electrode and the support array. Optionally, a touch screen may be placed in close contact with, e.g., directly on top of, the LCD panel for sensing coordinate positions of user touches/presses. Because the touch panel may be thin, presses on the touch screen may transfer to pressure-dependent deformation of the transparent electrode in the LCD panel at the point of press. Thus, the capacitance between the transparent electrode and the support array in the LCD panel may be monitored and used as a measure of touch pressure. The measurement of touch pressure adds another dimension to touch input for enhancing user-computer interaction.

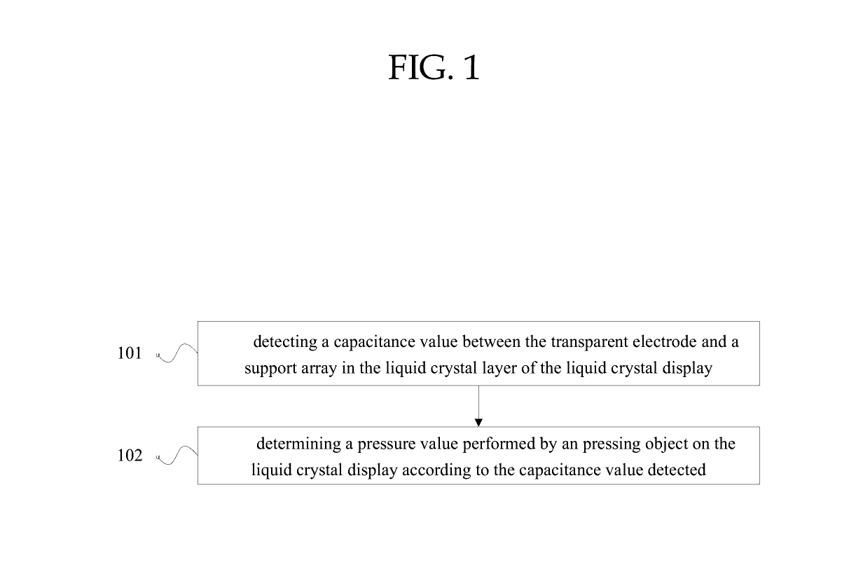

FIG. 1 shows an exemplary method for detecting touch pressure on an LCD panel. In step 101, a capacitance value between the transparent electrode and the support array in the liquid crystal layer of the LCD panel is measured (the geometrical relationship between the transparent electrode and support array is shown in FIG. 3 and FIG. 4 and will be discussed in more detail below). In step 102, a pressure exerted by a pressing object on the liquid crystal display is determined according to the capacitance value measured. The term “touch” and “press” are used interchangeably in this disclosure. A pressing object may include but is not limited to a fingertip, a finger knuckle, and a stylus. The pressing object may be also referred to as operation body.

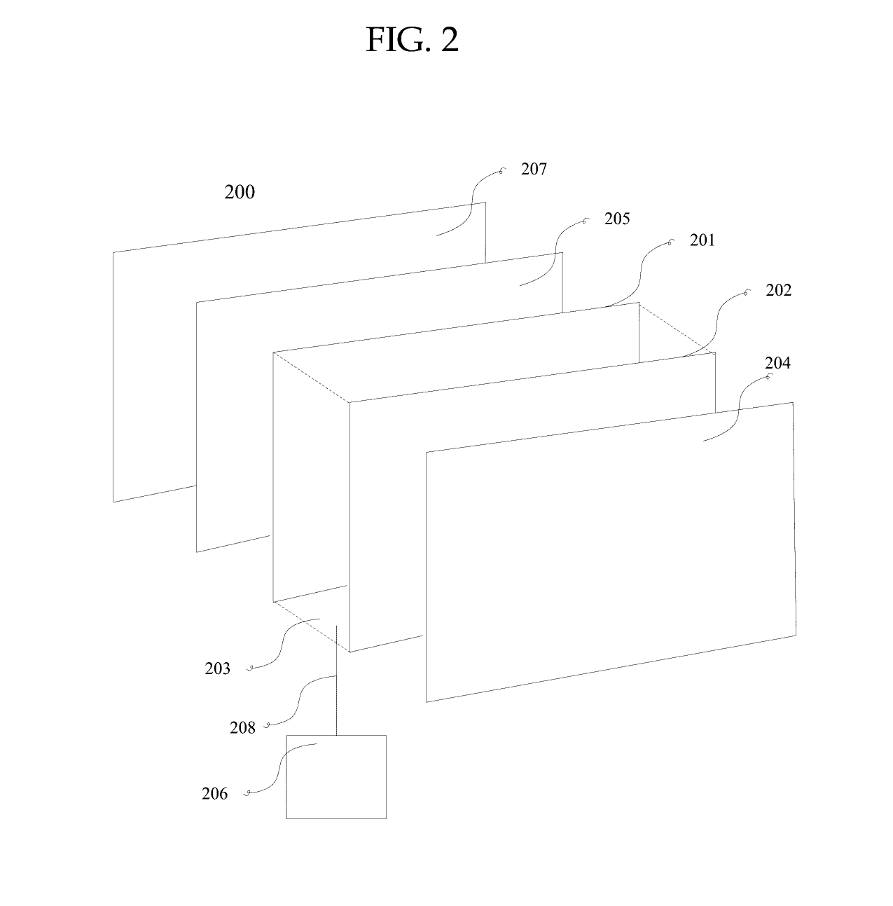

FIG. 2 illustrates a schematic diagram of a liquid crystal display. The liquid crystal display 200 comprises a TFT (Thin Film Transistor) array glass substrate 201, a color filter 202, a liquid crystal layer 203 arranged between the TFT array glass substrate 201 and the color filter 202, a first polarizer 204 arranged on a side of the color filter 202 away from the liquid crystal layer 203, and a second polarizer 205 arranged on a side of the TFT array glass substrate 201 away from the liquid crystal layer 203.

As shown by FIG. 3, the liquid crystal layer 203 may include a support array such as spacer structure 203-1 and a transparent electrode 203-2. The transparent electrode 203-2 may be placed in the liquid crystal layer on the side closer to the TFT array glass substrate 201 and the support array 203-1 may be placed in the liquid crystal layer on the side closer to the color filter 202. Liquid crystal is filled in the liquid crystal layer 203 between the support array 203-1 and the transparent electrode 203-2. Alternatively, as shown by FIG. 4, the transparent electrode 203-2 and the support array 203-1 may be placed in opposite sides of the liquid crystal layer. These two geometry configurations are mere examples, other arrangement may be contemplated. The transparent electrode may be, e.g., an ITO (indium tin oxide) glass which conducts electricity and at the same time transparent to back light of the LCD panel for producing images (back light is shown by 207 of FIG. 2).

As shown in FIG. 2, the liquid crystal display 200 may further include a control chip 206, and the transparent electrode 203-2 may be electrically connected with the control chip 206 via the electrical connection 208. The control chip 206 may be a MCU (Micro Controller Unit). The MCU also includes an A/D converter, which may convert an analogue voltage signal carried by the transparent electrode 203-2 to a digital voltage value, and the MCU may further calculate a capacitance value based on the voltage value.

In a first implementation, the transparent electrode 203-2 may be one single piece of transparent electrode, e.g., one single ITO layer that extends the entire liquid crystal layer. The support array 203-1 and the transparent electrode 203-2 are separated by a certain spatial distance filled with liquid crystal in the liquid crystal layer 203 and thus have no direct electrical contact. A capacitor is thus formed between the support array 203-1 and the transparent electrode 203-2. When the liquid crystal display 200 is not touched/pressed by a pressing object, the average distance between the support array 203-1 and the transparent electrode 203-2 is known, and so is the reference capacitance of the capacitor formed between the support array 203-1 and the transparent electrode 203-2. When the liquid crystal display 200 is pressed, a pressure-dependent deformation of the transparent electrode leads to pressure-dependent change in the average distance and thus capacitance between the support array 203-1 and the transparent electrode 203-2. Thus, the capacitance value may be monitored as a measure of pressure.

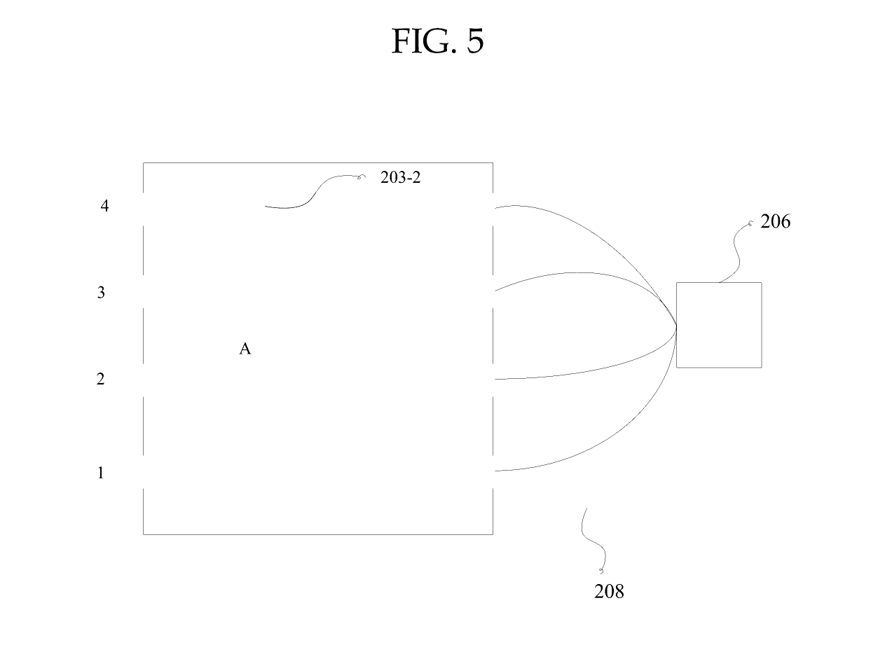

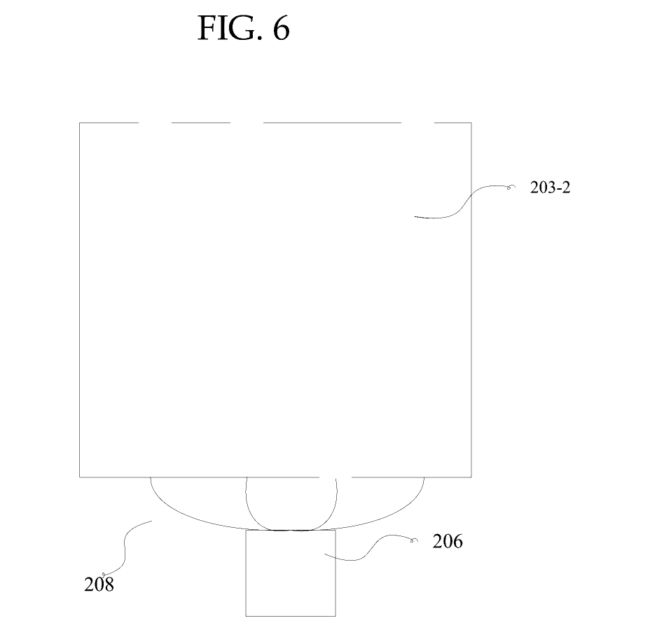

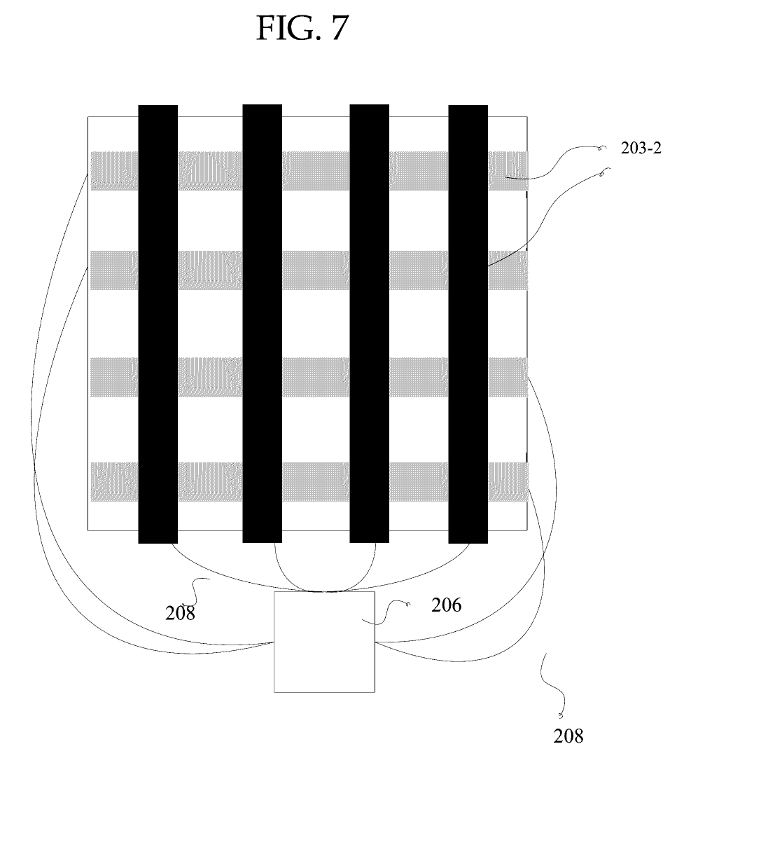

In some other alternative implementations, the transparent electrode 203-2 may comprise a plurality of transparent electrodes arranged as, for example, either transverse strips, longitudinal strips, or transvers and longitudinal crossing strips in the liquid crystal layer 203, as respectively illustrated in FIG. 5, FIG. 6, and FIG. 7. The term “transverse” and “longitudinal” are only meant to denote two orthogonal directions and are not in reference to any fixed axis. The strips running along the same direction may be electrically separate from each other by the distances between them in the plane of the liquid crystal layer 203. The strips running across each other (FIG. 7) may be electrically isolated by some insulating layer or distance between the crossing strips in the direction normal to the plane of the liquid crystal layer 203. In addition and similar to the first implementation, the support array 203-1 has no direct contact with each transparent electrode in the transparent electrodes 203-2 in the liquid crystal layer 203, and there may be a spatial separation between the support array 203-1 and each transparent electrode. A capacitor is formed between the support array 203-1 and each transparent electrode, and the number of capacitors corresponds to the number of transparent electrodes included in the transparent electrodes 203-2. When the liquid crystal display 200 is not touched/pressed by a pressing object, a reference distance between the support array 203-1 and each transparent electrode is known, and so is the reference capacitance value for each capacitor formed between the support array 203-1 and each transparent electrode in the transparent electrodes 203-2. Therefore, the reference capacitance value of each capacitor may be pre-detected and recorded and may be used as a reference to determine touch/press pressure when the liquid crystal display 200 is pressed by the pressing object. Generally, the rest distances (distance when there is no touch/press) between the support array 203-1 and each of the transparent electrodes 203-2 are identical, and therefore the capacitance values of the capacitors formed between the support array 203-1 and the transparent electrodes may be identical when the liquid crystal display 200 is not pressed by the pressing object. Thus the pre-detected reference capacitance value for any one of the transparent electrodes may be used as a common reference capacitance value when the liquid crystal display 200 is not pressed by the pressing object.

In the implementation of FIGS. 5-7, the MCU 206 may be electrically coupled to and thus address separately each electrode of the transparent electrode or electrodes 203-2. When 203-2 is referred to hereinafter, the term “electrode” or “electrodes” may either refer to a single electrode of FIG. 2 or multiple electrodes of FIGS. 5-7 unless specified otherwise. The analogue voltage signal in each electrode may be converted by the MCU to digital values for monitoring the capacitance between each of transparent electrodes 203-2.

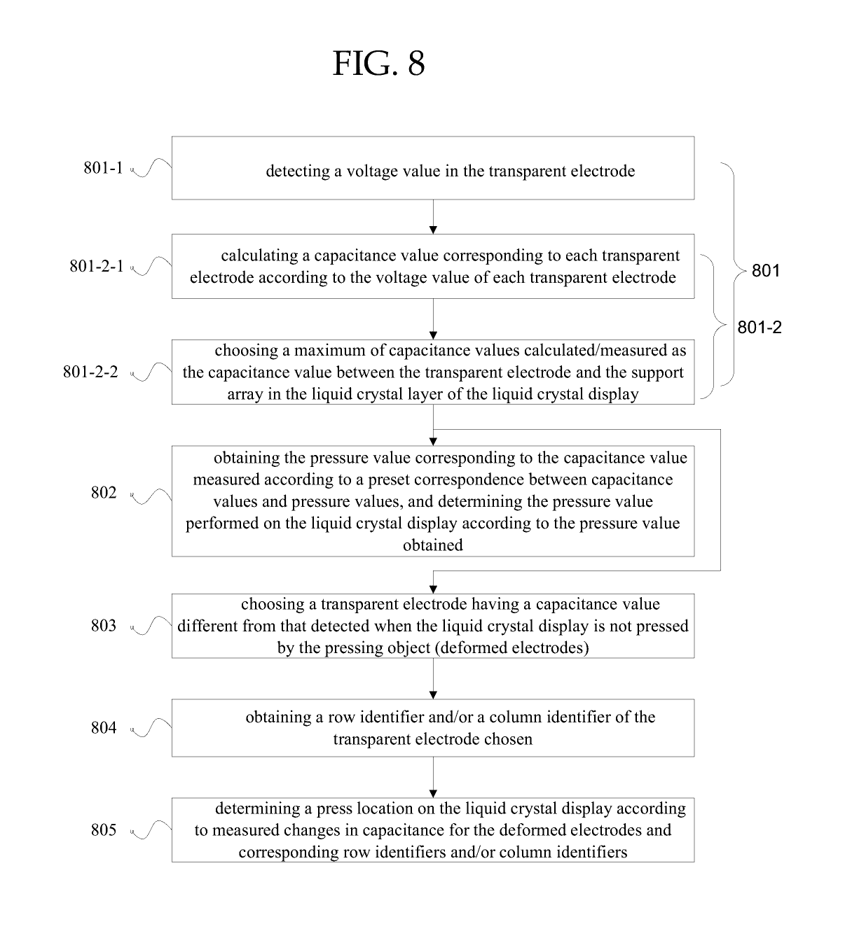

In some embodiments of the present disclosure, the pressure value on the liquid crystal display is determined by detecting the capacitance value between the transparent electrodes and the support array in the liquid crystal layer of the liquid crystal display, in addition to a one dimensional coordinate position detection that may be achieved in the configuration of FIG. 5 and FIG. 6 or a two-dimensional coordinate position detection that may be achieved in the configuration of FIG. 7 (see more details below in FIG. 8). This additional user input parameter (pressure) provides expanded functionality in human-computer interaction. The coordinate position detection may be alternatively achieved by a separate touch panel that is placed on top of the liquid crystal panel and is sufficiently thin that touch induced deformation of the transparent electrode in the liquid crystal panel and consequently the pressure measurement is not significantly impeded.

FIG. 8 shows a flow diagram of a method for detecting touch pressure in a mobile terminal. This method may be applied in an electronic device such as a mobile terminal and a tablet computer. The mobile terminal may comprise a liquid crystal display, a transparent electrode arranged in a liquid crystal layer of the liquid crystal display as illustrated in FIGS. 2-7. In step 801, capacitance value or values between the transparent electrode or electrodes and a support array in the liquid crystal layer of the liquid crystal display is detected and measured. For example, the control chip 206 may supply a predetermined amount of charges to a transparent electrode for charging the corresponding capacitor and generate a voltage across the transparent electrode and the support array. The control chip and associated circuity may measure and digitize the voltage. The control chip may calculate the capacitance value according to the voltage value and the predetermined charge amount. Accordingly, step 801 may be realized by steps as follows.

In step 801-1, a voltage value in the transparent electrode is detected/measured. In a first implementation of 801-1, the transparent electrode may be a whole transparent electrode as shown in FIG. 2 and thus one capacitor is formed between the support array and the single transparent electrode. In such an implementation, only one voltage value may be detected. Accordingly, the control chip only sends one charging signal to the entire transparent electrode via the electric connection 208 shown in FIG. 2. In a second implementation of 801-1, the transparent electrode consists of a plurality of transparent electrodes in a transverse and parallel arrangement and/or a plurality of transparent electrodes in a longitudinal and parallel arrangement, shown by FIGS. 5-7. Multiple capacitors may be formed by the transparent electrodes. The control chip then independently charges each capacitor and measures the voltage values via separate electric connections 208 as shown in FIGS. 5-7. Accordingly, in step 801-1 for this second implementation, voltage values on the multiple transparent electrodes many be measured periodically at a first preset time periodicity and in each time period, the multiple transparent electrodes are measured sequentially. The control chip may provide switching circuitry to sequentially address each electrode and a corresponding single A/D converter may be time-shared. Alternatively, the voltage values on the multiple transparent electrodes may be measured periodically in parallel at a second preset time periodicity. For such parallel detection and measurement, multiple set of A/D converters may be needed. Further for the second implementation, if the transparent electrodes comprises a plurality of transparent electrodes in both the transverse and longitudinal arrangement shown in FIG. 7, a row identifier or a column identifier of each transparent electrode may be preset, in which, rows and columns may be set corresponding to the geometrical arrangement for each transparent electrode in a transverse and parallel arrangement or in a longitudinal and parallel arrangement. The location of each transparent electrode in the liquid crystal display may be pre-determined corresponding to the row identifier or the column identifier. As will be shown with regard to step 803-805 below, these row and/or column identifiers and predetermined positions of the corresponding electrodes in the plane of the liquid crystal display may facilitate additional touch/press position detection.

In step 801-2, the capacitance value between the transparent electrode and the support array in the liquid crystal layer of the liquid crystal display is determined according to the measured voltage value. A correspondence between capacitance values and voltage values may be preset based on, for example, the predetermined amount of charge supplied to the capacitor, and the capacitance value is directly obtained from the correspondence according to the voltage value detected and measured. Step 801-2 may be implemented in two ways: 801-2-1 alone, and 801-2-1 and 801-2-2 together, respectively corresponding to the first and second implementation above for step 801-1. When there is only one capacitance value to be measured, i.e. the transparent electrode is a single transparent electrode as shown in FIG. 2 (corresponding to the first implementation of 801-1), the single capacitance value may be obtained directly from a correspondence between capacitance values and voltage values and used as the measured capacitance, as shown by step 801-2-1 alone. In an alternative implementation for step 801-2-1, the single capacitance may be determined by measuring the difference between the current capacitance with the known and pre-measured rest capacitance (when the liquid crystal display is not pressed by the pressing object). When there are a plurality of capacitors, i.e., 203-2 consists of a plurality of transparent electrodes illustrated in FIGS. 5-7 (corresponding to the second implementation of 801-1), the control chip determines multiple capacitance values based on measured voltage values for the multiple transparent electrodes in step 801-2-1, and then selects, for example, the maximum of measured capacitance values as a representative capacitance value for determining pressure in step 801-2-2. The transparent electrode having the maximum capacitance is likely to be the most deformed electrode among the plurality of electrodes. This is because a larger deformation of an electrode (caused by a harder press) leads to smaller average distance between the electrode and the support array and higher capacitance. Thus, the electrode with maximum capacitance is approximately located at the center of the pressure. Its capacitance may more accurately represent the magnitude of the pressure.

For displaying image frames by the liquid crystal display, voltages may be applied across the liquid crystal layer 203 of FIGS. 2-4 for biasing the liquid crystal cells (pixels) independent of the capacitance measurements. To avoid interference from these voltages during the touch pressure sensing process, step 801 (including 801-1 and 801-2) of detecting and measuring capacitance may be executed when the liquid crystal display 200 is in a blanking interval.

In step 802, the pressure value corresponding to the capacitance value detected and measured is obtained according to a preset correspondence between capacitance values and pressure values. The obtained pressure value is determined to represent the actual touch pressure on the liquid crystal display. The correspondence between the capacity value and pressure originates from the relationship between the pressure and deformation of the transparent electrodes and is fixed when the design and manufacturing of the liquid crystal panel is completed. The correspondence may thus be predetermined by experiments that measure both the pressure and capacitance under various pressing strength on the liquid crystal panel. In some implementations, the correspondence may be recalibrated by the user in case that it changes over time as the liquid crystal panel ages.

The steps 803, 804, and 805 in FIG. 8 are for locating the touch/press position when the transparent electrodes are configured as multiple electrodes, following, for example, FIGS. 5-7. For configurations in FIG. 5 and FIG. 6, only touch/press position in one dimension in the plane of the liquid crystal display may be determined. For the configuration of FIG. 7, touch/press position in both of the two dimensions in the plane of the liquid crystal display may be determined. The accuracy for determining the touch/press positon in each dimension may be determined at least partially by the number of transparent electrodes in that dimension. The steps 803, 804, and 805 for determining touch/press position may be before, after or in parallel with step 803. No limitation on the order is given by this disclosure.

In step 803, transparent electrodes having a change of capacitance value from when the liquid crystal display is not touched/pressed are identified. The capacitance value of non-pressed electrode may be referred to as a reference capacitance value. A touch/press may lead to change of capacitance for multiple transparent electrodes. The capacitance value between each electrode and the support array when the liquid crystal display is not touched/pressed may be pre-measured and recorded. Typically, capacitance between the support array and like electrodes, such as the strips in FIG. 5, or strips in FIG. 6, or the transvers strips in FIG. 7, or the longitudinal strips in FIG. 7, may be identical. In that situation, pre-measurement of capacitance may only need to be made for one electrode in each group.

In step 804, row identifiers and column identifiers of the transparent electrodes having changed capacitance are obtained. Specifically, the row identifier or the column identifier of each transparent electrode may be preset. Because the controller chip charge and read the voltage of each transparent electrode either in addressable sequence or in parallel, the controller chip may correlate measured capacitance values with row and/or column identifiers. A position calibration on the liquid crystal display may be performed according to the known coordinates of the row or column identifiers of the transparent electrodes. In step 805, a touch press location on the liquid crystal display is determined according to the row identifiers and/or the column identifiers obtained in step 805. Specifically, a touch/press may deform one or more transparent electrodes. The measured changes in capacitance as well as the positions for all affected electrode may be combined for determining the coordinate position of the touch/press.

For example, in FIG. 5, the longitudinal position of each transverse electrode relative to the longitudinal axis of the liquid crystal display is known from the fabrication design. The electrodes may be identified with row identifier 1 to 4, as shown in FIG. 5. When the liquid crystal panel is touched or pressed at spot A, both electrode 2 and 3 may be deformed. As a consequence, both the capacitance between electrode 2 and the support array and the capacitance between electrode 3 and the support array may be affected by the press. The control chip may measure the capacitance between all electrodes (1-4) and the support array and identify that electrodes 2 and 3 provide capacitances different from the no-touch reference values. Because the touch spot A is closer to electrode 2, electrode 2 may be deformed more than electrode 3. As a result, the measured capacitance between electrode 2 and the support array may be more affected by the touch/press than the capacitance between electrode 3 and the support array. The control chip may measure the changes in capacitance for both electrode 2 and electrode 3 and use them as weight (e.g., linear weight) to average the known longitudinal positions of electrode 2 and 3. The position of electrode 2 may accordingly be weighed more heavily. Thus, the control chip may approximately identify the touch spot A as closer to electrode 2 than to electrode 3. Similar principles may be used for the electrode configuration of FIG. 6 except that transverse rather than longitudinal position of the touch/press may be determined. Similar principles may further be used for the electrode configuration of FIG. 7, except that both transverse and longitudinal positions of the touch/press may be determined.

In embodiments of the present disclosure, the pressure value on the liquid crystal display is determined by detecting the capacitance value between the transparent electrode and the support array in the liquid crystal layer of the liquid crystal display, in addition to determining coordinate positions of the touch/press. Thus, more functionality may be realized based on the pressure detection and human-computer interaction may be improved.

The embodiments above and hereafter use liquid crystal display panel as an example. The principle described in this disclosure applies to systems other than liquid display panels. For example, structures similar to the transparent electrodes 203-2 of FIGS. 3-7 may be implemented in an OLED (Organic LED) display panel for pressure and coordinate position detection of touches/presses.

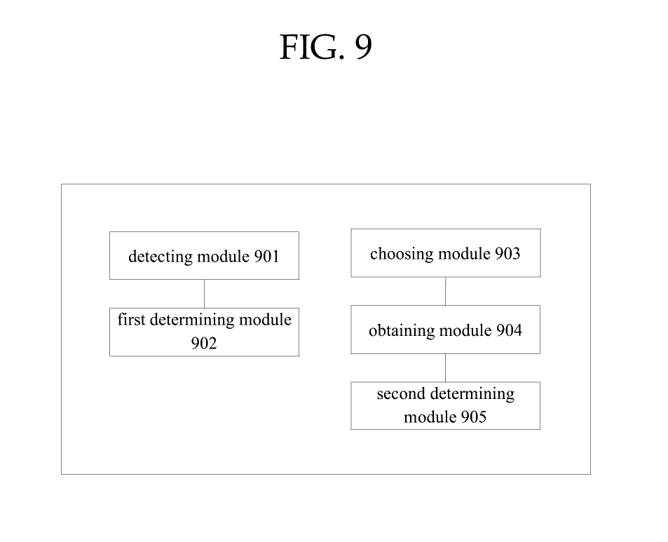

Corresponding to the methods for detecting touch pressure in a liquid crystal display panel provided in the example embodiments above, FIG. 9 illustrate an exemplary device for detecting pressure in a mobile terminal having a liquid crystal display, and a transparent electrode arranged in a liquid crystal layer of the liquid crystal display. The device of FIG. 9 includes a detecting module 901 and a first determining module 902. The detecting module 901 is configured to detect capacitance values between the transparent electrodes and a support array in the liquid crystal layer of the liquid crystal display, preferably during a blanking interval of the liquid crystal display. The first determining module 902 is configured to determine a pressure value exerted by a pressing object on the liquid crystal display according to the capacitance values detected based on a preset correspondence between capacitance values and pressure values.

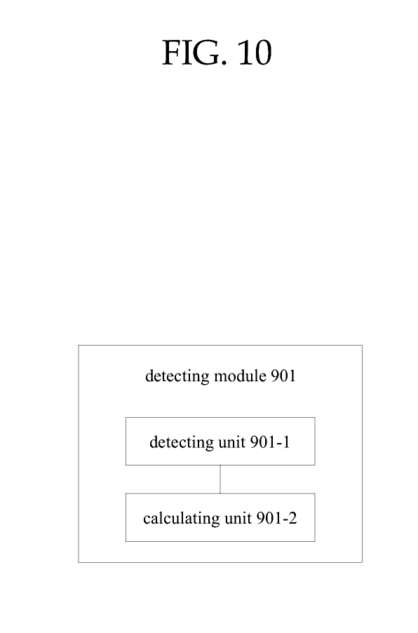

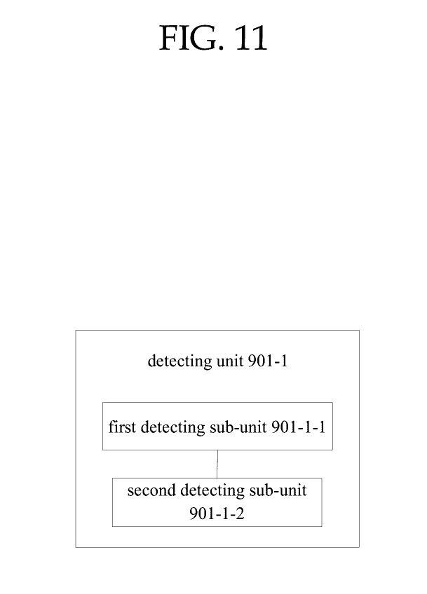

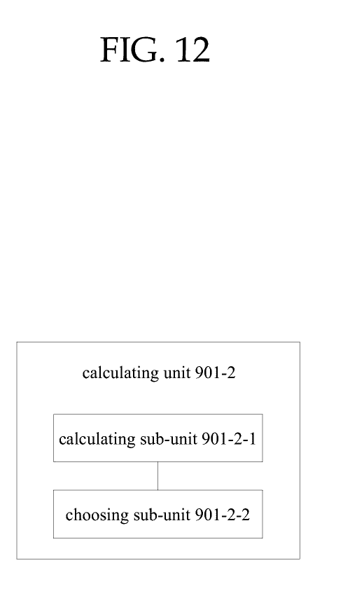

As shown in FIG. 10, the detecting module 901 is configured to detect capacitance values and may include a detecting unit 901-1 and a calculating unit 901-2. The detecting unit 901-1 is configured to detect voltage values in the transparent electrodes. The calculating unit 901-2 is configured to calculate the capacitance values between the transparent electrodes and the support array in the liquid crystal layer of the liquid crystal display according to the voltage value. The transparent electrodes may comprise a plurality of transparent electrodes in a transverse and parallel arrangement and/or a plurality of transparent electrodes in a longitudinal and parallel arrangement, and as shown in FIG. 11, the detecting unit 901-1 includes a first detecting sub-unit 901-1-1 and a second detecting sub-unit 901-1-2. The first detecting sub-unit 901-1-1 is configured to detect a voltage value of each transparent electrode one by one sequentially according to a first preset period. The second detecting sub-unit 901-1-2 is configured to detect a voltage value of each transparent electrode simultaneously according to a second preset period. As shown in FIG. 12, the calculating unit 901-2 of FIG. 10 may comprise a calculating sub-unit 901-2-1 and a choosing sub-unit 901-2-2. The calculating sub-unit 901-2-1 is configured to calculate a capacitance value corresponding to each transparent electrode according to the voltage value in each transparent electrode. The choosing sub-unit 901-2-2 is configured to choose a maximum of capacitance value calculated as the capacitance value between the transparent electrode and the support array in the liquid crystal layer of the liquid crystal display.

Returning to FIG. 9, the device further includes a choosing module 903, an obtaining module 904 and a second determining module 905. The choosing module 903 is configured to choose transparent electrodes having capacitance values different from those detected when the liquid crystal display is not pressed by the pressing object. The obtaining module 904 is configured to obtain row identifiers and column identifiers of the transparent electrodes chosen. The second determining module 905 is configured to determine a press location on the liquid crystal display according to the measured change of capacitance for the chosen transparent electrodes and the corresponding row and column identifiers.

Thus, in the embodiment of FIG. 9, the pressure value on the liquid crystal display is determined by detecting the capacitance value between the transparent electrodes and the support array in the liquid crystal layer of the liquid crystal display, in addition to coordinate position detection of the touch/press. More functionality based on detected touch pressure may be realized, providing improved human-computer interaction.

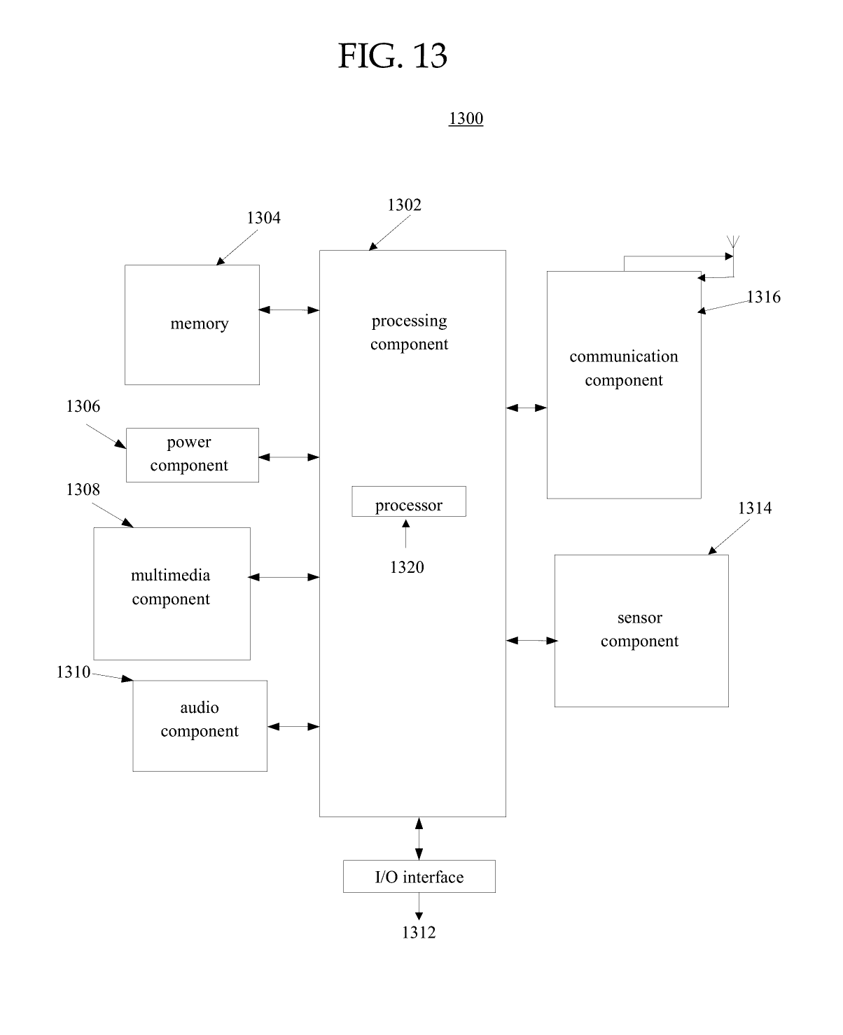

FIG. 13 shows a block diagram of a device 1300. For example, the device 1300 may be a mobile phone, a tablet computer, a laptop computer, a digital broadcasting terminal, a messaging device, a game console, a tablet device, a fitness equipment, a Personal Digital Assistant PDA, etc.

Referring to FIG. 13, the terminal 1300 may include the following one or more components: a processing component 1302, a memory 1304, a power component 1306, a multimedia component 1308, an audio component 1310, an Input/Output (I/O) interface 1312, a sensor component 1314, and a communication component 1316.

The processing component 1302 controls overall operations of the terminal 1300, such as the operations associated with display, telephone calls, data communications, camera operations, and recording operations. The processing component 1302 may include one or more processors 1320 to execute instructions to perform all or part of the steps in the above described methods. Moreover, the processing component 1302 may include one or more modules which facilitate the interaction between the processing component 1302 and other components. For instance, the processing component 1302 may include a multimedia module to facilitate the interaction between the multimedia component 1308 and the processing component 1302.

The memory 1304 is configured to store various types of data to support the operation of the terminal 1300. Examples of such data include instructions for any applications or methods operated on the terminal 1300, contact data, phonebook data, messages, pictures, video, etc. The memory 1304 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1306 provides power to various components of the terminal 1300. The power component 1306 may include a power management system, one or more power sources, and any other components associated with the generation, management, and distribution of power in the terminal 1300.

The multimedia component 1308 includes a display screen or panel providing an output interface between the terminal 1300 and the user. In some embodiments, the screen may include a liquid crystal display (LCD) panel or a OLED panel and a touch panel (TP). If the screen includes the touch panel, the screen may be implemented as a touch screen to receive input signals from the user. The touch panel includes one or more touch sensors to sense touches, swipes, and other gestures on the touch panel. The touch sensors may not only sense a boundary of a touch or swipe action, but also sense a duration time and a pressure associated with the touch or swipe action. The display screen panel may have integrated therein the transparent electrodes and support arrays illustrated in FIGS. 3-7 and discussed above. In some embodiments, the multimedia component 1308 includes a front camera and/or a rear camera. The front camera and the rear camera may receive external multimedia data while the terminal 1300 is in an operation mode, such as a photographing mode or a video mode. Each of the front camera and the rear camera may be a fixed optical lens system or have focus and optical zoom capability.

The audio component 1310 is configured to output and/or input audio signals. For example, the audio component 1310 may include a microphone (MIC) configured to receive an external audio signal when the intelligent terminal 1300 is in an operation mode, such as a call mode, a recording mode, and a voice recognition mode. The received audio signal may be further stored in the memory 1304 or transmitted via the communication component 1316. In some embodiments, the audio component 1310 further includes a speaker to output audio signals.

The I/O interface 1312 provides an interface for the processing component 1302 and peripheral interface modules, such as a keyboard, a click wheel, buttons, and the like. The buttons may include, but are not limited to, a home button, a volume button, a starting button, and a locking button.

The sensor component 1314 includes one or more sensors to provide status assessments of various aspects of the terminal 1300. For instance, the sensor component 1314 may detect an open/closed status of the terminal 1300 and relative positioning of components (e.g. the display and the keypad of the terminal 1300). The sensor component 1314 may also detect a change in position of the terminal 1300 or of a component in the terminal 1300, a presence or absence of user contact with the terminal 1300, an orientation or an acceleration/deceleration of the terminal 1300, and a change in temperature of the terminal 1300. The sensor component 1314 may include a proximity sensor configured to detect the presence of nearby objects without any physical contact. The sensor component 1314 may also include a light sensor, such as a CMOS or CCD image sensor, for use in imaging applications. In some embodiments, the sensor component 1314 may also include an accelerometer sensor, a gyroscope sensor, a magnetic sensor, a pressure sensor, or a temperature sensor or thermometer.

The communication component 1316 is configured to facilitate wired or wireless communication between the terminal 1300 and other devices. The terminal 1300 can access a wireless network based on a communication standard, such as Wi-Fi, 2G, 3G, LTE, or 4G cellular technologies, or a combination thereof. In one exemplary embodiment, the communication component 1316 receives a broadcast signal or broadcast associated information from an external broadcast management system via a broadcast channel. In one exemplary embodiment, the communication component 1316 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the terminal 1300 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, a non-transitory computer readable storage medium is provided. The storage medium includes instructions, when executed by the processor 1320 in the terminal 1300, causing the processor 1320 to perform the above-described methods. For example, the non-transitory computer-readable storage medium may be a ROM, a RAM, a CD-ROM, a magnetic tape, a floppy disc, an optical data storage device, and the like.

Each module or unit discussed above for FIG. 9-12, such as the detecting module, the first determining module, the choosing module, the obtaining module, the second determining module, the detecting unit, the calculating unit, the first detecting sub-unit, the second detecting sub-unit, the calculating sub-unit, and the choosing sub-unit may take the form of a packaged functional hardware unit designed for use with other components, a portion of a program code (e.g., software or firmware) executable by the processor 1320 or the processing circuitry that usually performs a particular function of related functions, or a self-contained hardware or software component that interfaces with a larger system, for example.

The illustrations of the embodiments described herein are intended to provide a general understanding of the structure of the various embodiments. The illustrations are not intended to serve as a complete description of all of the elements and features of apparatus and systems that utilize the structures or methods described herein. Other embodiments of the disclosure will be apparent to those skilled in the art from consideration of the specification and practice of the embodiments disclosed herein. This application is intended to cover any variations, uses, or adaptations of the disclosure following the general principles thereof and including such departures from the present disclosure as come within known or customary practice in the art. It is intended that the specification and examples are considered as exemplary only, with a true scope and spirit of the invention being indicated by the following claims in addition to the disclosure.

It will be appreciated that the present invention is not limited to the exact construction that has been described above and illustrated in the accompanying drawings, and that various modifications and changes can be made without departing form the scope thereof. It is intended that the scope of the invention only be limited by the appended claims.

What is claimed is:

1. A method for detecting touch pressure on a display panel comprising at least one transparent electrode, the method comprising:
detecting capacitance values corresponding to each of at least one capacitor formed between the at least one transparent electrode and a support array in the display panel;
determining a representative capacitance value from the detected capacitance values; and
determining a pressure value exerted on the display panel according to at least the representative capacitance value.

2. The method of claim 1, wherein the display panel comprises a liquid crystal display panel and the at least one transparent electrode is arranged in a liquid crystal layer of the liquid crystal display panel.

3. The method according to claim 1, wherein detecting the capacitance values comprises:
detecting voltage values each corresponding to a respective one of the at least one transparent electrode; and
calculating the capacitance values corresponding to each of the at least one capacitor formed between the at least one transparent electrode and the support array according to the detected voltage values.

4. The method according to claim 3,
wherein the at least one transparent electrode comprises a plurality of transparent electrodes in a transverse and parallel arrangement and/or in a longitudinal and parallel arrangement; and
wherein detecting the voltage values comprises:
detecting periodically the voltage values corresponding to the plurality of transparent electrodes in time sequence according to a first preset periodicity; or
detecting periodically the voltage values corresponding to the plurality of transparent electrodes simultaneously according to a second preset periodicity.

5. The method according to claim 4,
wherein calculating the capacitance values comprises calculating the capacitance values corresponding to the plurality of transparent electrodes according to the detected voltage values of the plurality of transparent electrodes; and
wherein determining the representative capacitance value comprises choosing a maximum of the calculated capacitance values as the representative capacitance value.

6. The method according to claim 4, further comprising:
identifying from the plurality of transparent electrodes a subset of transparent electrodes each having a calculated capacitance value different from a corresponding reference capacitance value detected when the display panel is not pressed;
obtaining row identifiers and column identifiers of the identified subset of transparent electrodes; and
determining a press coordinate location on the display panel according to at least one of the calculated capacitance values of the subset of transparent electrodes, and the row identifiers and the column identifiers obtained.

7. The method according to claim 1, wherein determining the pressure value exerted on the display panel according to at least the representative capacitance value comprises:
obtaining a calculated pressure value corresponding to the representative capacitance value according to a preset correspondence between capacitance values and pressure values; and
determining the pressure value exerted on the liquid crystal display according to the calculated pressure value.

8. The method according to claim 2, wherein detecting the capacitance values of the at least one capacitor between the at least one transparent electrode and the support array in the liquid crystal layer of the liquid crystal display panel comprises:
detecting the capacitance values during a blanking interval of the liquid crystal display panel.

9. A device comprising:
a display panel;
at least one transparent electrode in the display panel;
a support array in the display panel; and
a processor configured to:
detect capacitance values corresponding to each capacitor formed between the at least one transparent electrode and the support array in the display panel;
determine a representative capacitance value from the detected capacitance values; and
determine a pressure value exerted on the display panel according to at least the representative capacitance value.

10. The device of claim 9, wherein the display panel comprises a liquid crystal display panel and the at least one transparent electrode is arranged in a liquid crystal layer of the liquid crystal display panel.

11. The device according to claim 9, wherein, to detect the capacitance values, the processor is configured to:
detect voltage values each corresponding to a respective transparent electrode; and
calculate the capacitance values corresponding to each capacitor formed between the at least one transparent electrode and the support array according to the detected voltage values.

12. The device according to claim 11,
wherein the at least one transparent electrode comprises a plurality of transparent electrodes in a transverse and parallel arrangement and/or in a longitudinal and parallel arrangement; and
wherein to detect the voltage values, the processor is configured to:
detect periodically the voltage values corresponding to the plurality of transparent electrodes in time sequence according to a first preset periodicity; or
detect periodically the voltage values corresponding to the plurality of transparent electrodes simultaneously according to a second preset periodicity.

13. The device according to claim 12,
wherein, to calculate the capacitance values corresponding to the capacitors formed between the at least one transparent electrode and the support array, the processor is configured to calculate the capacitance values corresponding to the plurality of transparent electrodes according to the detected voltage values of the plurality of transparent electrodes; and
wherein, to determine the representative capacitance value, the processor is configured to choose a maximum of the calculated capacitance values as the representative capacity value.

14. The device according to claim 12, wherein the processor is further configured to:
identify from the plurality of transparent electrodes a subset of transparent electrodes each having a calculated capacitance value different from a corresponding reference capacitance value detected when the display panel is not pressed;
obtain row identifiers and column identifiers of the identified subset of transparent electrodes; and
determine a press coordinate location on the display panel according to at least one of the calculated capacitance values of the subset of transparent electrodes, and the row identifiers and the column identifiers obtained.

15. The device according to claim 9, wherein, to determine the pressure value exerted on the display panel, the processor is configured to:
obtain a calculated pressure value corresponding to the representative capacitance value according to a preset correspondence between capacitance values and pressure values; and
determine the pressure value exerted on the liquid crystal display according to the calculated pressure value.

16. The device according to claim 10, wherein, to detect the capacitance values of each capacitor between the at least one transparent electrode and the support array in the liquid crystal layer of the liquid crystal display panel, the processor is configured to:
detect the capacitance values during a blanking interval of the liquid crystal display.

17. A non-transitory computer readable storage medium having stored therein instructions that, when executed by a processor of an electronic device having at least one transparent electrode in a display panel, cause the electronic device to:
detect capacitance values corresponding to each capacitor formed between the at least one transparent electrode and a support array in the display panel;
determine a representative capacitance value from the detected capacitance values; and
determine a pressure value exerted on the display panel according to at least the representative capacitance value.
